(19) United States
(12) Patent Application Publication
(10) Pub. No.: US 2010/0185552 A1
(43) Pub. Date: Jul. 22, 2010

(54) PROVIDING GPS-BASED LOCATION AND TIME INFORMATION

(75) Inventors: Lisa Seacat DeLuca, San Francisco, CA (US); Samuel I. Ward, Austin, TX (US)

Correspondence Address: MOLLBORN PATENTS, INC., 2840 COLBY DRIVE, BOULDER, CO, 80305, US

(73) Assignee: INTERNATIONAL BUSINESS MACHINES CORPORATION, Armonk, NY (US)

(21) Appl. No.: 12/718,199

(22) Filed: Mar. 5, 2010

Related U.S. Application Data
(63) Continuation-in-part of application No. 12/355,621, filed on Jan. 16, 2009, now abandoned.

(51) Int. Cl. G01S 19/24; G06Q 30/00; G06F 17/30

(52) U.S. Cl. 705/347; 342/357.07; 707/802; 707/781; 707/723; 707/E17.044; 707/E17.005; 707/769; 707/E17.014; 707/E17.018

(57) ABSTRACT

Methods and apparatus, including computer program products, implementing and using techniques for providing data pertaining to a one or more users' visits to an establishment. A location of one or more global positioning system devices is determined. Each global positioning system device is associated with a user of the device. One or more establishments situated at each determined location are identified. One or more of a time of day and a duration of the user's visit to the establishment is determined. One or more of the location, the time of day and the duration of the user's visit are recorded in a database.

### CROSS-REFERENCE TO RELATED APPLICATIONS

This application is a continuation-in-part (CIP) of U.S. patent application Ser. No. 12/355,621 entitled “METHOD AND APPARATUS FOR PROVIDING GPS-BASED CREDIBILITY RATING” filed on Jan. 16, 2009, the entire content of which is incorporated herein by reference.

### BACKGROUND

This disclosure relates to the provision of location information based on Global Positioning System (GPS) technologies. GPS is a space-based navigation satellite system, which provides reliable positioning, navigation and timing services to users across the world on a continuous basis, as long as the user's device has an unobstructed view of four or more GPS satellites. GPS has become a widely used aid to navigation, as well as a useful tool for map-making, land surveying, commerce, scientific uses, tracking and surveillance etc. Also, the precise time-reference used in GPS system is used in many applications including the scientific study of earthquakes and as a time synchronization source for cellular network protocols.

In recent years, GPS receiver technologies have become widespread in a range of consumer devices, such as dedicated GPS receivers, cellular telephones, Personal Digital Assistants (PDAs), etc. Often, the GPS receiver is combined with various types of software, e.g., mapping applications that give a user spoken directions for how to get from point A to point B, applications that provide the user with information about nearby restaurants, or factual information about nearby historical monuments, etc. GPS devices have also been used in GPS Pet Tracking devices, which typically are attached to the collars of the pets and use the same network of satellites to pinpoint and transmit information about the whereabouts of a missing pet. These are merely a few examples of the many uses of GPS technologies in today's society.

### SUMMARY

In general, in one aspect, the invention provides methods and apparatus, including computer program products, implementing and using techniques for providing data pertaining to a one or more users' visits to an establishment. A location of one or more global positioning system devices is determined. Each global positioning system device is associated with a user of the device. One or more establishments situated at each determined location are identified. One or more of a time of day and a duration of the user's visit to the establishment is determined. One or more of the location, the time of day and the duration of the user's visit are recorded in a database.

Various embodiments can include one or more of the following features. The information recorded in the database can be refined. Refining can include aggregating the information in the database on an establishment-basis to provide statistical information for one or more of the establishments, based on the time of day and duration entries in the database for the one or more establishments. Refining can include aggregating the information in the database on a global positioning system device-basis to provide information about a single user's preferences, based on one or more of: the visited establishment, the time of day and the duration entries in the database for the user's global positioning system device.

A user request to access data in the database can be received. It can be verified that the user submitting the request has permission to access the requested data. The data in the database can be processed to provide a response to the user's request, and the processed data can be provided to the user in response to the request. A review can be received from a reviewer concerning the establishment. The database can be queried to determine whether the reviewer, wherein the reviewer is associated with a particular global positioning system device, has visited the location of the establishment or whether the reviewer has visited a location nearby the establishment at a prior time. The database can be queried to determine the duration of any visit at or nearby the location of the establishment. The credibility of the review can be rated as a function of the proximity of the global positioning system device to the location of the establishment and the duration of the visit.

Rating the credibility can include rating the credibility as poor in response to determining at least one of: that there is no record in the database of the reviewer having visited the location of the establishment or a location nearby the establishment at a prior time, and that the reviewer was nearby or at the establishment only at a time when the establishment was known to be closed. Rating the credibility can include rating the credibility as high in response to determining at least one of: that there are records in the database of the reviewer having frequented the establishment regularly, and that the review is provided in close temporal proximity to the reviewer's visit to the establishment.

The credibility rating can be provided to an end user, without disclosing the credibility rating to the reviewer. The reviewer can be notified of a proposed credibility rating prior to publication of the review and instructions can be received from the reviewer as to whether the review should be published or not.

The various embodiments can be used to realize one or the more of the following advantages. Information about individuals' preferences and general habits can be collected and be used for providing recommendations to the individuals. The collection of information can occur on a voluntary basis and have various levels of anonymity associated. Statistical information can be obtained on a location- or time-basis, which allows, for example, owners of establishments to evaluate the success of certain measures taken, such as marketing campaigns, or compare current visitor data with visitor data from previous time periods. Data about establishments visited before a current establishment for a set of users can indicate potential partnership and cross-advertisement opportunities.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a system (100) for location and time tracking of users in accordance with one embodiment.

FIG. 2 shows a process (200) for recording time and location data for a user, in accordance with one embodiment.

FIG. 3 shows a process (300) for how a user can access the information recorded in the database (108) at a later point in time.

FIG. 4 shows a flowchart for a process (400) for assigning a credibility rating to a review, in accordance with one embodiment.

FIG. 5 shows a flowchart for a process (500) for assigning credibility rating to a review when the reviewer has not visited the establishment under review, in accordance with one embodiment.

Like reference symbols in the various drawings indicate like elements.

### DETAILED DESCRIPTION

### Overview

The various embodiments described herein pertain to location and time tracking using devices equipped with GPS receivers, hereinafter referred to as “GPS devices.” In particular, the various embodiments relate to methods and apparatus for tracking the location of a user of a GPS device, as well as how much time is spent in a particular location or geographical area, and subsequently evaluating this information for various purposes. As the basic functionality of GPS devices is well-known to those of ordinary skill in the art, the following examples will focus on various ways in which the time and location information recorded by the GPS device can be used. It should also be understood that while the examples below are described with respect to GPS devices, any other type of location-determination device can also be used in these applications, as long as the location can be determined with sufficient accuracy for the particular application. For example, in some cases a cellular network identifier, a wireless access point (WAP) media access control (MAC) address, or some different kind of navigational system can be used. Thus, the examples described below are by no means exclusive.

Various embodiments of the invention will now be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

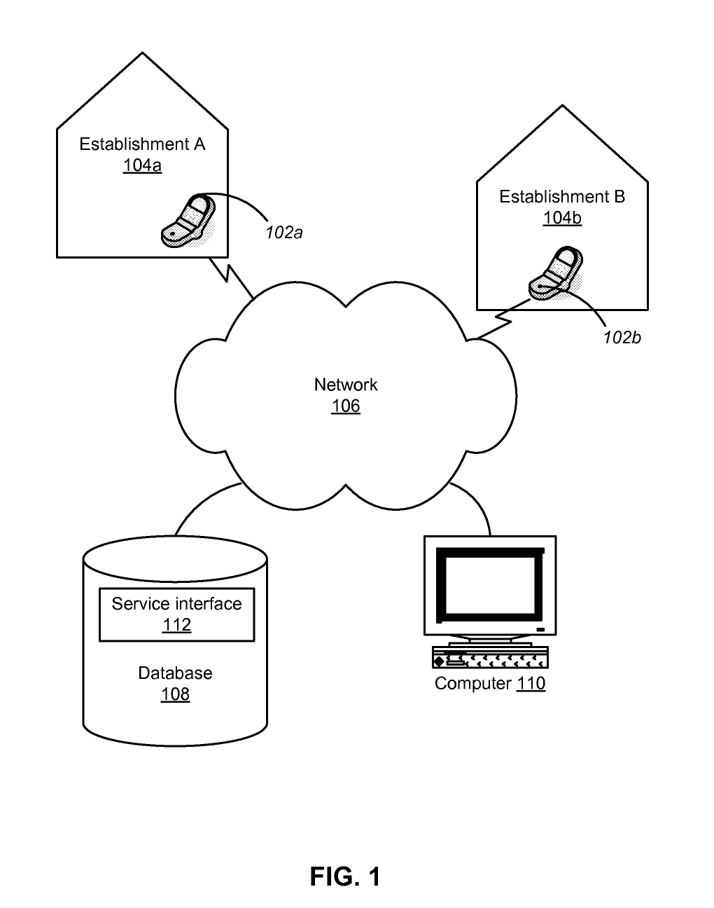

FIG. 1 shows a system (100) for location and time tracking of users in accordance with one embodiment. As can be seen in FIG. 1, the system (100) includes one or more GPS devices (102a, 102b). In the illustrated embodiment, only two GPS devices are shown, one for User A (102a) and one for User B (102b). It should be realized however, that in a real-life system, there can be thousands or tens of thousands of such GPS devices, where each GPS device typically is associated with a single user. In FIG. 1, User A is visiting an Establishment A (104a), and User B is visiting an Establishment B (104b), which is located at a different geographical location from Establishment A (104a).

The locations and times spent in the respective establishments is recorded by the GPS devices (102a, 102b) and is sent over a network (106) to a database (108) where the information is stored. The transmission of the location data over the network (106) can be done using any conventional mechanisms that are familiar to those of ordinary skill in the art. In most cases, the transmission is done through wireless means, but of course the location and time data can also be stored in the GPS devices themselves, and then be downloaded through a wired connection to the database (108) at a later point in time.

At any point after the location and time data has been recorded in the database (108), a user can access the stored data by means of a computing device (110), which may be a stationary computer, a laptop, a PDA, a cell phone and the like. These users can be, for example, the owners of Establishment A (104a) or Establishment B (104b), who may be interested in obtaining data about the visits to their respective establishments. Typically, a service interface (112) is provided in the database (108), which can be used to restrict the particular types of data that are available to the users (110), as will be described below. The service interface (112) can also be used to perform various aggregation functions, such as determining the average length of a user's visit to an establishment, illustrating variations in the length of visits on a daily basis or comparing weekly numbers, etc., which will also be described in further detail below.

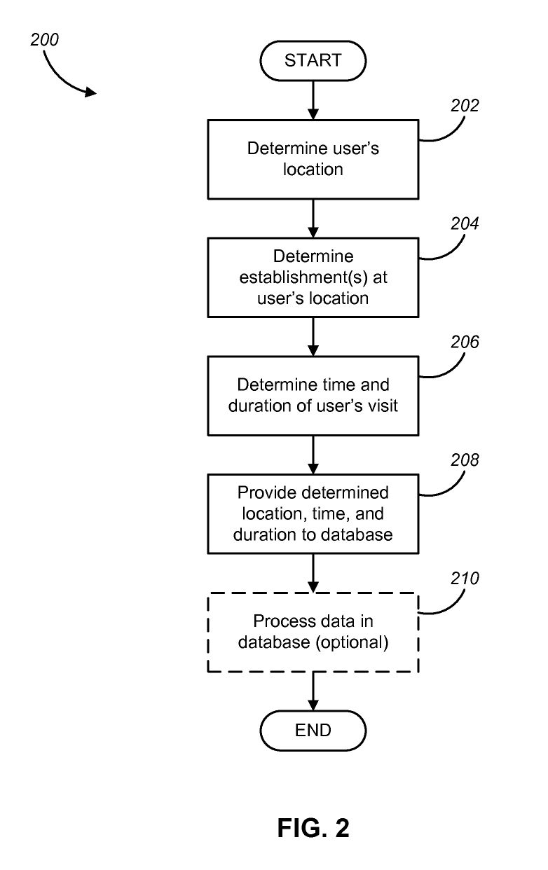

FIG. 2 shows a process (200) for recording time and location data for a user, in accordance with one embodiment. As can be seen in FIG. 2, the process (200) starts with determining a location of the user's GPS device (step 202). Next, it is determined what establishment is located at the user's determined location (step 204). This can for example be done by querying a database or registry that correlates locations of establishments with geographical coordinates. After the establishment has been determined, the time of day and the duration of the visit is recorded (step 206), and the recorded information is provided to the database (108) (step 208). In some embodiments, there may be an optional processing step 210, in which the received time and location data is further processed before the process (200) ends. For example, if it is determined in step 204 that there are multiple establishments at the determined user location, the time of day data and the duration of the visit can in some cases provide an indication as to which establishment a user visited. For example, if there is a lunch restaurant and a night club at the same location, and the user visited the location between 10 p.m. and 1 a.m., it would be reasonable to infer that the user visited the night club and not the lunch restaurant. Similarly, if there is a movie theatre and a convenience store at the same location and the duration of the visit is approximately 2 hours, it would be reasonable to infer that the user visited the movie theatre and not the convenience store. It should be realized that these are only examples, and many variations can be realized by those of ordinary skill in the art, and based on the particular types of establishments at different locations. In some implementations, the user might also be sent a text message asking them to specify which location they visited, if it is not possible to infer the information based on the received data and the logic of the system.

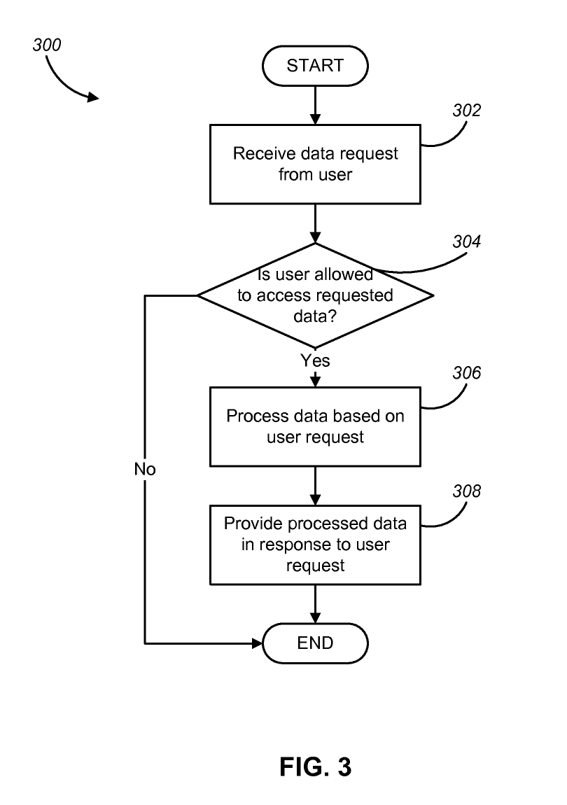

FIG. 3 shows a process (300) for how a user can access the information recorded in the database (108) at a later point in time. As can be seen in FIG. 3, the process starts by receiving a request for data from the user (110) (step 302). In some implementations a user interface can be provided on the user's computer (110), which contains a menu listing all available types of data that can be accessed from the database (108), while in other implementations the user is free to specify any data that they would like to access. Next, the service interface (112) determines whether the user (110) is allowed to access the requested data in the database (108) (step 304). This determination can be made based on a number of factors. For example, if the user is the owner of Establishment A (104a), they may only be permitted to access data pertaining to Establishment A (104a) and be denied any access to data pertaining to their rival Establishment B (104b). On the other hand, they may be able to access data that compares their own establishment with average data for a group of establishments, such as a particular category of businesses in a particular geographical area, etc. If the user is a law enforcement agency, they could potentially get unlimited access to all data in the database, and so on. As the reader realizes, there are many possibilities of allowing or restricting user access to the information in the database, which can be realized by those of ordinary skill in the art.

If it is determined in step 304 that the user is not allowed to access the requested data, the user is informed to that effect, and the process ends. On the other hand, if it is determined in step 304 that the user does have access permissions to the requested data, the data is processed or otherwise aggregated based on the user's request (step 306) and the processed data is provided to the user (step 308), which ends the process (300). There can be many types of processing of data in step 306, and the processed data can be further analyzed and processed by the user for a variety of purposes. Some examples of such processing will now be described. It should, however, be realized that the examples below are merely intended to illustrate some ways in which the time and location data can be used, and that the list is by no means exhaustive. Many variations can be realized by those of ordinary skill in the art. Two main distinctions can be made, though: use of individual data, vs. use of aggregated data for a large number of individuals.

In one embodiment, the data collected for individual GPS devices can be used to track individual behavior. For example, by tracking what establishments, such as shops or restaurants a given individual frequents regularly, it would be possible to send targeted advertising or marketing messages to that individual's GPS device. This information could also be used to send recommendations of new establishments or upcoming events to the user's GPS device that the user might be interested in, based on previously attended establishments or events. The recommendations can also be further refined based on the user's reviews of her experiences at these locations. For example, if the user was dissatisfied with the establishment, the establishment could offer some kind of incentive to the user to entice her to come back.

In some embodiments, the techniques described above can be used for providing GPS-based credibility rating of a reviewer's submitted review of an establishment, based on the time and location information collected by the GPS device associated with the reviewer. The proliferation of Internet has provided immediate access to thousands of reviews on goods and services. A user of a product or a service can readily post comments on the internet promoting or disparaging the product or service. While the previous generation of reviews was conducted by professionals with some level of authority on the subject they reviewed, the Internet reviews are often posted anonymously. As such the credibility of the reviewer is never established. To the extent that the reviewer has no vested interest in the quality or accuracy of the review, the review can be inaccurate or baseless.

By verifying, at the time the reviewer elects to provide a review of an establishment, whether the reviewer has visited the location of the establishment or a location near the establishment, based on the recorded time and location data of a GPS device associated with the reviewer, the system can provide a credibility rating for the review. For example, if there is no record of the reviewer having been at or near the establishment under review, the credibility rating will be poor. On the other hand, when the GPS records indicate that the user has frequented the establishment regularly, or that review was provided in close temporal proximity to the reviewer's visit to the establishment, the credibility rating will be high. Other factors that can influence the credibility rating can be, for example, the number of visits the reviewer has made to the establishment under review, the duration of each visit and other special considerations. These other special considerations can for example include whether it can be established that the reviewer has some kind of authority, such as a high skill level or specialization, with respect to the goods or services under review.

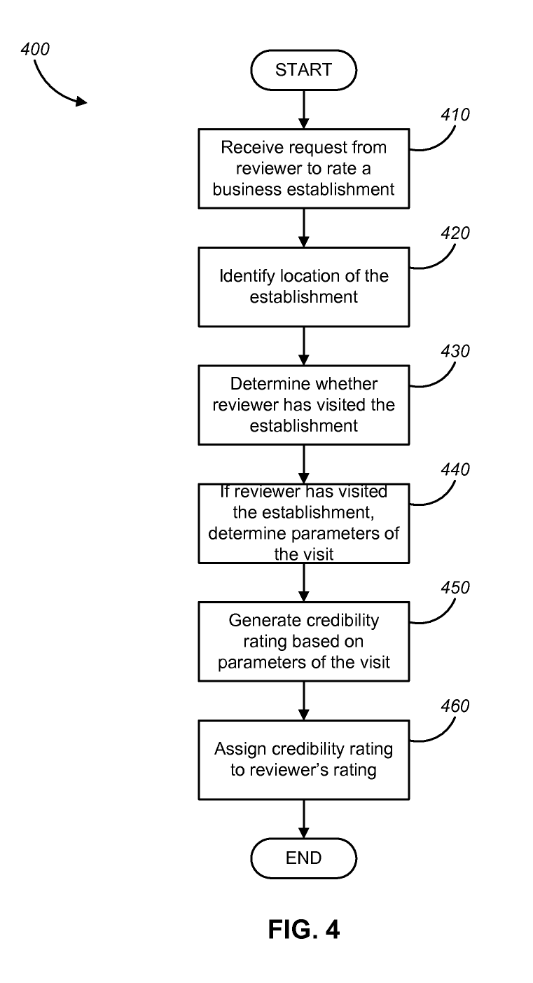

FIG. 4 shows a flowchart for a process (400) for assigning a credibility rating to a review, in accordance with one embodiment. As can be seen in FIG. 4, in step 410 the system (100) receives a request or a notification from the reviewer of her intent to review an establishment. In step 420, the location of the establishment under review is identified. Similar to what was described above, the location can be readily identified by the use or the system may determine the location of the establishment by accessing an online database. In yet another embodiment, the location can be determined iteratively through a series of question-and-answer dialogs with the reviewer.

Next, in step 430, the system (100) determines whether the reviewer has visited the establishment, based on the GPS data recorded in the database (108) for the user's GPS device. Alternatively, the system (100) may query the user's GPS device itself, if the time and location information is stored locally within the GPS instead of in the database (108). The parameters of the reviewer's visit of the establishment are then determined in step 440. As was described above, these parameters can include such information as the date and time of the visit, the duration of the visit and whether the reviewer was present at the establishment or was in its proximity. For example, if the reviewer's GPS device is integrated with the reviewer's vehicle rather than in a handheld device and the reviewer is reviewing a diner at a shopping center, the provided information can help assess credibility of a claim that the reviewer was at or near the establishment under review.

In step 450, the system determines a credibility rating for the review. The credibility rating can be a function of the parameters of step 140. For example, if the GPS data indicates that the reviewer has not been at or near the location of the establishment, a poor credibility rating is provided. Alternatively, if the reviewer was at or near the establishment only at a time when the establishment is known to be closed (e.g., evenings or holidays), the review is rated poorly. Conversely, if the review is submitted at a time when the reviewer is at the establishment under review, the credibility ratings can be high. In various implementations the reviewer can provide her review while at the establishment under review or after the fact.

Finally, in step 460, the credibility rating is assigned to the review. Any conventional rating technique can be used. The credibility rating can be provided directly to the end-user without revealing the ratings to the reviewer. Alternatively, the reviewer can be notified of the rating assigned to the review prior to publication of the review and be allowed to decline from posting the review if the ratings are not adequately rated.

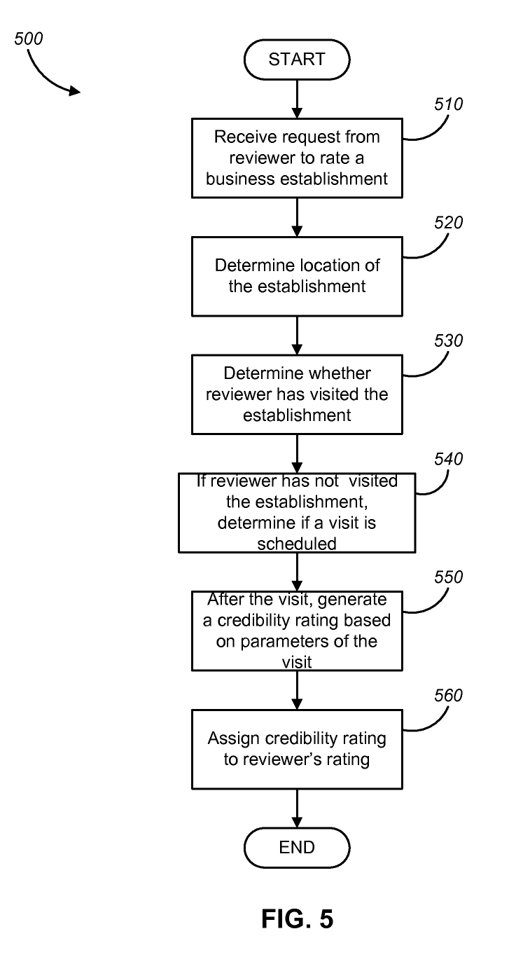

FIG. 5 shows a flow-diagram for assigning credibility rating to a review when the reviewer has not visited the establishment under review. In step 510, the system receives a request from a reviewer of its intent to review an establishment. In step 520, the system determines the location of the establishment. The reviewer can provide the location of the establishment or the system can on its own initiate steps to determine the location of the establishment. If the system determines the location of the establishment, the reviewer can be given the option of confirming the location of the review.

At step 530, an inquiry is then made to determine whether the reviewer has actually visited the establishment under review or has been in the proximity of the location. If the inquiry suggests that the reviewer has not visited or been in the proximity of the establishment, at step 540 the system determines whether a visit to the establishment is scheduled. Step 540 can be implemented, for example, by requesting the reviewer to identify the anticipated visit. If the reviewer has not visited the establishment and does not intend to visit the establishment prior to publishing its review, the system can ignore the review, not release the review for posting or rate the review as having low credibility. Assuming that a later visit to the establishment is scheduled, at step 550, the system determines the parameters of the visit as described above. Finally, at step 260, the system generates ratings to assess the quality of the review.

On an aggregate level, the collected data from multiple GPS devices can be used for example for statistical purposes, such as how much time the average person spends in an establishment or how many people visited an establishment. This data can be aggregated based on, for example, the time of day, day of the week, month, year, etc. In some implementations, the data can be compared with previous data, for example, to see how the numbers for a given day compares to last week, last month, last year, etc., or to see what kind of change a particular advertising or promotional campaign caused in the number of visits and their duration in a particular establishment. Social networks can also be taken into account to determine locations that are frequented by a user's friends or associates, and advertisements or other incentives can be provided to the user with the assumption that she has similar interests and tastes as her friends, regardless of whether she has visited the locations in the past.

Of course, for privacy reasons, it is important that there are possibilities for the users to opt out of the systems and methods described herein. A user may decide not to disclose any location or time information at all, or she may choose to allow collection of time and location recordings during business hours, but not during evenings and weekends, etc. The user may also choose to share the time and location data, but in an anonymous fashion, that is, that no personal details are associated with the information that is being shared. The only information that is recorded is that a given GPS device was at a given location during certain time periods. As the skilled person realizes, there are many further versions of data sharing restrictions that can be implemented and which fall within the scope of the appended claims.

The flowcharts and block diagrams in the figures referred to above illustrate the architecture, functionality, and operation of possible implementations of systems, methods and computer program products according to various embodiments of the invention. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, various embodiments of the invention can include a system, method or computer program product. Accordingly, the invention can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the invention can take the form of a computer program product embodied in any tangible medium of expression having computer-usable program code embodied in the medium.

Any combination of one or more computer usable or computer readable medium(s) can be used. The computer-usable or computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium can be any medium that can contain, store, communicate, propagate, or transport the program for use by or in connection with the instruction execution system, apparatus, or device. The computer-usable medium can include a propagated data signal with the computer-usable program code embodied therewith, either in baseband or as part of a carrier wave. The computer usable program code can be transmitted using any appropriate medium, including but not limited to wireless, wireline, optical fiber cable, RF, and so on.

Computer program code for carrying out operations of the invention can be written in any combination of one or more programming languages, including an object oriented programming language such as Java, Smalltalk, C++ or the like and conventional procedural programming languages, such as the “C” programming language or similar programming languages. The program code can execute entirely on the subscriber's computer, partly on the subscriber's computer, as a stand-alone software package, partly on the subscriber's computer and partly on a remote computer or entirely on the remote computer or server. In the latter scenario, the remote computer can be connected to the subscriber's computer through any type of network, including a local area network (LAN) or a wide area network (WAN), or the connection can be made to an external computer (for example, through the Internet using an Internet Service Provider).

A number of implementations of the invention have been described. Nevertheless, it will be understood that various modifications may be made without departing from the spirit and scope of the invention. For example, users' GPS devices can be associated with social networks, which would allow analysis based on data collected for a group of friends or associates. Various types of demographics can also be associated with the users' device, which would allow further analysis based on demographic factors in combination with the location and time data described above. Accordingly, other embodiments are within the scope of the following claims.

1. A method for providing data pertaining to a one or more users' visits to an establishment, the method comprising:
determining a location of one or more global positioning system devices, wherein each global positioning system device is associated with a user of the device;
identifying one or more establishments situated at each determined location;
determining one or more of: a time of day and a duration of the user's visit to the establishment; and
recording in a database one or more of: the location, the time of day and the duration of the user's visit.

2. The method of claim 1, further comprising:
refining the information recorded in the database.

3. The method of claim 2, wherein refining includes:
aggregating the information in the database on an establishment-basis to provide statistical information for one or more of the establishments, based on the time of day and duration entries in the database for the one or more establishments.

4. The method of claim 2, wherein refining includes:
aggregating the information in the database on a global positioning system device-basis to provide information about a single user's preferences, based on one or more of: the visited establishment, the time of day and the duration entries in the database for the user's global positioning system device.

5. The method of claim 1, further comprising:
receiving a user request to access data in the database;
verifying that the user submitting the request has permission to access the requested data;
processing the data in the database to provide a response to the user's request; and
providing the processed data to the user in response to the request.

6. The method of claim 1, further comprising:
receiving a review from a reviewer concerning the establishment;
querying the database to determine whether the reviewer, wherein the reviewer is associated with a particular global positioning system device, has visited the location of the establishment or whether the reviewer has visited a location nearby the establishment at a prior time;
querying the database to determine the duration of any visit at or nearby the location of the establishment; and
rating the credibility of the review as a function of the proximity of the global positioning system device to the location of the establishment and the duration of the visit.

7. The method of claim 6, wherein rating the credibility includes:
rating the credibility as poor in response to determining at least one of:
that there is no record in the database of the reviewer having visited the location of the establishment or a location nearby the establishment at a prior time, and
that the reviewer was nearby or at the establishment only at a time when the establishment was known to be closed.

8. The method of claim 6, wherein rating the credibility includes:
rating the credibility as high in response to determining at least one of:
that there are records in the database of the reviewer having frequented the establishment regularly, and
that the review is provided in close temporal proximity to the reviewer's visit to the establishment.

9. The method of claim 6, further comprising:
providing the credibility rating to an end user, without disclosing the credibility rating to the reviewer.

10. The method of claim 6, further comprising:
notifying the reviewer of a proposed credibility rating prior to publication of the review; and
receiving instructions from the reviewer as to whether the review should be published or not.

11. A computer program product for providing data pertaining to a one or more users' visits to an establishment, the computer program product comprising:
a computer usable medium having computer usable program code embodied therewith, the computer usable program code comprising:
computer usable program code configured to determine a location of one or more global positioning system devices, wherein each global positioning system device is associated with a user of the device;
computer usable program code configured to identify one or more establishments situated at each determined location;
computer usable program code configured to determine one or more of: a time of day and a duration of the user's visit to the establishment; and
computer usable program code configured to record in a database one or more of: the location, the time of day and the duration of the user's visit.

12. The computer program product of claim 11, further comprising:
computer usable program code configured to refine the information recorded in the database.

13. The computer program product of claim 12, wherein the computer usable program code configured to refine includes:
computer usable program code configured to aggregate the information in the database on an establishment-basis to provide statistical information for one or more of the establishments, based on the time of day and duration entries in the database for the one or more establishments.

14. The computer program product of claim 12, wherein the computer usable program code configured to refine includes:
computer usable program code configured to aggregate the information in the database on a global positioning system device-basis to provide information about a single user's preferences, based on one or more of: the visited establishment, the time of day and the duration entries in the database for the user's global positioning system device.

15. The computer program product of claim 11, further comprising:
computer usable program code configured to receive a user request to access data in the database;
computer usable program code configured to verify that the user submitting the request has permission to access the requested data;
computer usable program code configured to process the data in the database to provide a response to the user's request; and
computer usable program code configured to provide the processed data to the user in response to the request.

16. The computer program product of claim 11, further comprising:
computer usable program code configured to receive a review from a reviewer concerning the establishment;
computer usable program code configured to query the database to determine whether the reviewer, wherein the reviewer is associated with a particular global positioning system device, has visited the location of the establishment or whether the reviewer has visited a location nearby the establishment at a prior time;
computer usable program code configured to query the database to determine the duration of any visit at or nearby the location of the establishment; and
computer usable program code configured to rate the credibility of the review as a function of the proximity of the global positioning system device to the location of the establishment and the duration of the visit.

17. The computer program product of claim 16, wherein the computer usable program code configured to rate the credibility includes:
computer usable program code configured to rate the credibility as poor in response to determining at least one of:
that there is no record in the database of the reviewer having visited the location of the establishment or a location nearby the establishment at a prior time, and
that the reviewer was nearby or at the establishment only at a time when the establishment was known to be closed.

18. The computer program product of claim 16, wherein the computer usable program code configured to rate the credibility includes:
computer usable program code configured to rate the credibility as high in response to determining at least one of:
that there are records in the database of the reviewer having frequented the establishment regularly, and
that the review is provided in close temporal proximity to the reviewer's visit to the establishment.

19. The computer program product of claim 16, further comprising:
computer usable program code configured to provide the credibility rating to an end user, without disclosing the credibility rating to the reviewer.

20. The computer program product of claim 16, further comprising:
computer usable program code configured to notify the reviewer of a proposed credibility rating prior to publication of the review; and
computer usable program code configured to receive instructions from the reviewer as to whether the review should be published or not.

21. A system for providing data pertaining to a one or more users' visits to an establishment, the system comprising:
one or more global positioning system devices, wherein each global positioning system device is associated with a user and is operable to provide a location of the global positioning system device and an associated time stamp for when the location was determined;
a database operable to store one or more of: the locations and timestamps provided by the global positioning system devices; and
a service interface operable to:
receive a user request pertaining to at least some of the locations and timestamps stored in the database;
determine whether the user has permission to access the data specified in the request; and
in response to determining that the user has permissions to access the data, process the user request and provide the results of the processed request to the requesting user.
